(19) United States
(12) Patent Application Publication
(10) Pub. No.: US 2005/0284392 A1
(43) Pub. Date: Dec. 29, 2005

(54) Portable pet waste station

(76) Inventor: Kathleen T. Hillman, Jupiter, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/880,285

(22) Filed: Jun. 29, 2004

(51) Int. Cl. A01K 1/035

(52) U.S. Cl. 119/169

(57) ABSTRACT

A portable pet waste station can include an exterior shell defining a urine collection chamber and a rigid mesh screen disposed atop the urine collection chamber. Importantly, the portable pet waste station can include a non-rigid permeable pad disposed atop the mesh shell. In this regard, preferably the non-rigid permeable pad can be one of a washeable pad and a disposable pad. The portable pet waste station can also include a urine reservoir disposed below the urine collection chamber and communicatively coupled to the urine collection chamber with a hole. Moreover, a bottom surface of the urine collection chamber can be sloped towards the hole so as to encourage the flow of urine towards the hole and into the urine reservoir. To facilitate the clean, comfortable and convenient disposal of pooled urine in the portable pet waste station, an actuatable valve can be affixed to the shell to permit draining of urine collected in the station to an exterior disposal location. In this regard, the valve can be configured for coupling to a hose.

### FIELD OF THE INVENTION

The present invention relates to a litter box and more particularly to a portable pet waste disposal station.

### BACKGROUND OF THE INVENTION

While pets have long proven worthwhile to many persons, pets, like children, come at a cost. Aside from food and medical concerns, pets generally evacuate several times each day. By evacuation, it is meant that pets both urinate and defecate. Notably, while for many pets, evacuation merely represents an exercise in impulse, most pets are able to be trained so as to evacuate only at certain times and in certain places. Classically, dogs have been trained to evacuate outside at selected times of the day, and cats have been trained to evacuate indoors using the venerable litter box. Interestingly, even less typical pets such as ferrets, rabbits, possums and such have been trained to utilize a litter box when the need for evacuation arises.

Generally, a litter box consists of an impermeable container filled with absorbent material such as litter, newspaper and such which can absorb urine and which can be disposed of handily. Litter, in particular, has experienced dramatic advances in composition over the past two decades and now can serve the function of both an absorbent material and also an odor-fighting material. As such, pet owners fortunate to maintain pets trained to use a litter box can enjoy the benefit of pet ownership with a minimum of inconvenience associated with pet waste collection and disposal.

Litter boxes are known to have been manufactured in a variety of forms. Simple litter boxes are mere containers or plastic cartons. More sophisticated litter boxes also have been proposed. For example, in U.S. Pat. No. 6,745,719 to Howerton for LITTER SIFTING DEVICE FOR A LITTER BOX, an insertable tray is proposed in which a permanent mesh screen forming the bottom of the tray can be inserted into the litter box. When one desires to remove fecal matter from the litter box, the lifting of the tray can cause the sifting of the litter leaving only the desired fecal matter disposed on the surface of the mesh screen. Of course, cleaning the mesh screen can be a messy and uncomfortable proposition for pet owners.

In U.S. Pat. No. 5,355,837 to Reyes for CANINE TRAINER AND TOILET STATION, a fixed and permanent mesh also can be placed over a litter box. Unlike Howerton, however, it is suggested in Reyes that newspaper and not litter is to be placed above the fixed mesh so as to absorb some urine or fecal matter. The remaining urine can pass through the mesh into a reservoir which can be drained at will. As in the case of Howerton, however, draining the reservoir can be both messy and uncomfortable for pet owners. Accordingly, it is no surprise the Reyes device has seen little commercial success in the marketplace.

In U.S. Pat. No. 4,649,578 to Vargo for KITTY BOX, a unique combination of communicating chambers is proposed in which liquid passing through a permanent mesh can enter an antechamber before flowing into an isolated and remote chamber through a hole. Urine can be encourage to flow through the hole due to the sloped nature of the base of the antechamber. A similar sloping mechanism will be apparent in U.S. Pat. No. 2,390,854 to Thompson for ANIMAL TOILET. In either case, however, the typical pet owner will be compelled to engage in the messy and uncomfortable process of maintaining the permanent mesh. Moreover, flushing the reservoir can be equally as messy and undesirable spills can result.

In more particular illustration, FIG. 1 is a diagram depicting an advanced prior art litter box incorporating the teachings of Vargo and Thompson. Referring to FIG. 1, the litter box 100 can be defined by an impermeable outer shell 110 and can include a sloping upper chamber base 120 leading into a hole 170 communicatively coupled to a lower reservoir 160. Urine 180 can flow through a rigid, permeable mesh screen 1550, onto the sloping upper chamber base 120, down through the hole 170, and into the reservoir 160 thereby inhibiting the emanation of urine odor from the litter box 100. Despite the reduction in urine odor, however, the problem of cleaning and maintaining the litter box 100 remains. Particularly where the permeable mesh screen 150 can be rigid in nature requiring manual cleaning.

To facilitate the problem of disposing of urine in a urine reservoir in a litter box, it has been proposed to incorporate a hose into the base of a litter box to channel water into the litter box so as to dilute the content of the reservoir and to facilitate cleaning. In this regard, U.S. Pat. No. 3,762,368 to Barnum for PET SANITARY FACILITY includes a flexible tube for flushing the contents of a urine reservoir by coupling the hose to a sink or tub faucet. As it will be recognized by the skilled artisan, however, the messy and uncomfortable task of disposing of the diluted urine remains making the Barnum device as undesirable as other prior art litter boxes.

Commercially distributed litter boxes mostly address the requirements of cat and other small pet owners. To that end, owners of large pets including medium and large breed dogs heretofore have been unable to recognize the conveniences associated with litter box type technologies. Rather, it is presumed that large pet owners are to always “turn out” their dogs when necessary, including in the midst of a thunderstorm, in the middle of the night, or even when a suitable outside area is not readily available such as in the case of a high-rise apartment complex or hotel.

In U.S. Pat. No. 6,079,363 to MacLain for PORTABLE CANINE WASTE STATION, a portable dog litter box is proposed, including a retractable cover, removable wicks, a removable wire mesh screen and live grass mats. As in the case of the prior art litter boxes for cats, however, cleaning the MacLain waste station can be messy and uncomfortable. Accordingly, portable pet waste station would be desirable in which the cleaning and maintenance of the waste station does not require a messy and uncomfortable process and which does not require continuous maintenance to avoid an odiferous and unsanitary condition. Also, a portable pet waste station would be desirable which can suffice as an animal waste station for use in places which ordinarily cannot accommodate pet waste, such as the balcony of a tall building.

### SUMMARY OF THE INVENTION

The present invention advantageously provides a portable pet waste station which overcomes the limitations of the prior art and provides a novel and non-obvious pet waste disposal system and method which facilitates the portable collection and disposal of pet waste. In a preferred aspect of the present invention, a portable pet waste station can include an exterior shell defining a urine collection chamber and a rigid mesh screen disposed atop the urine collection chamber. Importantly, the portable pet waste station can include a non-rigid permeable pad disposed atop the mesh shell. In this regard, preferably the non-rigid permeable pad can be one of a washable pad and a disposable pad.

In a preferred aspect of the invention, the portable pet waste station can also include a urine reservoir disposed below the urine collection chamber and communicatively coupled to the urine collection chamber with a hole. Moreover, a bottom surface of the urine collection chamber can be sloped towards the hole so as to encourage the flow of urine towards the hole and into the urine reservoir. To facilitate the clean, comfortable and convenient disposal of pooled urine in the portable pet waste station, an actuatable valve can be affixed to the shell to permit draining of urine collected in the station to an exterior disposal location. In this regard, the valve can be configured for coupling to a hose.

Importantly, the rigid mesh shell can be a plastic shell able to support the weight of a dog—preferably a medium sized or large breed of dog. Alternatively, the rigid mesh shell can be a metal shell able to support the weight of a dog. In either case, the non-rigid permeable pad preferably can be an artificial grass section able to be washed in a conventional washing machine. Finally, a first splash guard can be arranged perpendicularly to a horizontal plane defined by the non-rigid permeable pad. Also, a second splash guard can be arranged perpendicularly both to a horizontal plane defined by the non-rigid permeable pad, and a vertical plane defined by the first splash guard.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side elevation illustrating a dual chamber litter box with a sloping upper chamber base as is known in the art;

FIG. 2 is a side elevation illustrating a portable pet waste station configured in accordance with a preferred aspect of the present invention;

FIG. 3 is a perspective view of the portable pet waste station of FIG. 2 configured with a washeable pad and permeable mesh screen in accordance with the inventive arrangements; and,

FIG. 4 is a pictorial illustration of a system and method for collecting and disposing of pet waste using the portable pet waste station of FIG. 2.

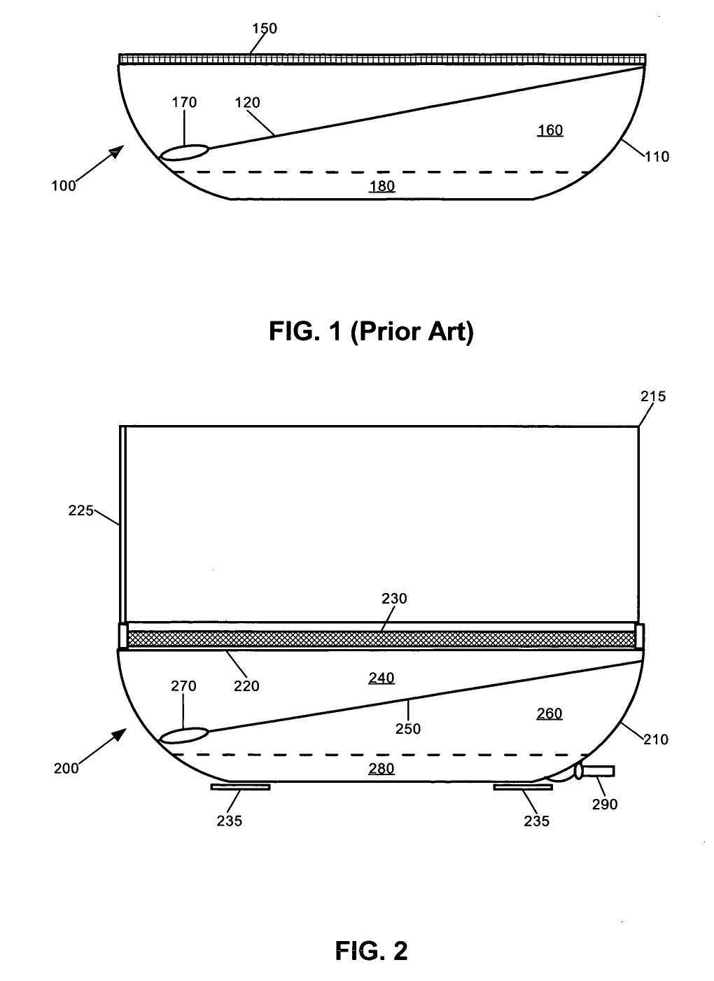

### DETAILED DESCRIPTION OF THE INVENTION

The present invention is a portable pet waste station. In accordance with the present invention, a portable pet waste station can include an upper urine collection chamber communicatively coupled to a lower urine reservoir chamber. Preferably, the base of the upper urine collection chamber can be sloped towards a hole opening into the lower urine reservoir chamber. A mesh screen can be disposed over the upper urine collection chamber and can be configured to receive a removable, permeable pad. Notably, the permeable pad can be either washable, disposable or both. To that end, preferably the permeable pad is a washable artificial turf section. Finally, an actuatable valve can be affixed to the lower urine reservoir chamber so as to permit the coupling of a hose section to the lower urine reservoir chamber to permit the selective draining of urine in the lower urine reservoir chamber to a suitable disposal area such as an outdoor lawn or an indoor toilet bowl.

In more specific illustration of a preferred embodiment of the present invention, FIG. 2 is a side elevation illustrating the portable pet waste station of the present invention. The portable pet waste station 200 can be defined by an impermeable outer shell 210 and can include an upper urine collection chamber 240 disposed above a lower urine reservoir chamber 260. The chambers 240, 260 can be communicatively coupled to one another through the hole 270. Preferably, the base 250 of the upper urine collection chamber 240 can be sloped towards the hole 270 so as to encourage urine in the upper urine collection chamber 240 to flow through the hole 270 into the lower urine reservoir chamber 260. In the lower urine reservoir chamber 260, standing urine 280 can collect while the positioning of the upper urine collection chamber 240 over the lower urine reservoir chamber 260 can inhibit the emanation of odor from the lower urine reservoir chamber 260.

Importantly, a mesh screen 220 such as a plastic or wire mesh screen can be removable disposed atop the upper urine collection chamber 240. The mesh screen 220 can include a permeable mesh surface so as to permit the free flow of urine and other liquid through the mesh screen 220 into the upper urine collection chamber 240. To provide a pre-filter to the mesh screen 220 and to collect fecal and other solid matter, a non-rigid, permeable pad 230 can be disposed atop the mesh screen 220. Of particular significance, the non-rigid, permeable pad 230 can be either washable or disposable. In this regard, the non-rigid, permeable pad 230 can be a section of artificial turf able to be cleaned within a conventional washing machine.

Notably, additional convenience features can be included in the preferred aspect of the present invention. For example, a front splash guard 225 and a side splash guard 215 can be arranged substantially perpendicularly to the horizontal plane defined by the permeable pad 230. The splash guards 215, 225 can be used to limit the travel of stray urine drops during an act of urination by a pet such as a dog. As an additional convenience feature, an actuatable valve 290 can be affixed to a channel defined through the exterior shell 210 near the bottom of the lower urine reservoir chamber 260. Through an actuation of the valve 290, the urine 280 can flow through the valve 290 and into a disposal region such as a toilet bowl or grass. To facilitate the transport of the urine 280 from the lower urine reservoir 260 to the disposal region, a hose or other tube-like device can be coupled to the valve 290. Finally, both suction cup feet 235 for stabilizing the portable pet waste station 200, and also a travel cover (not shown) for covering the top of the portable pet waste station 200 can be provided.

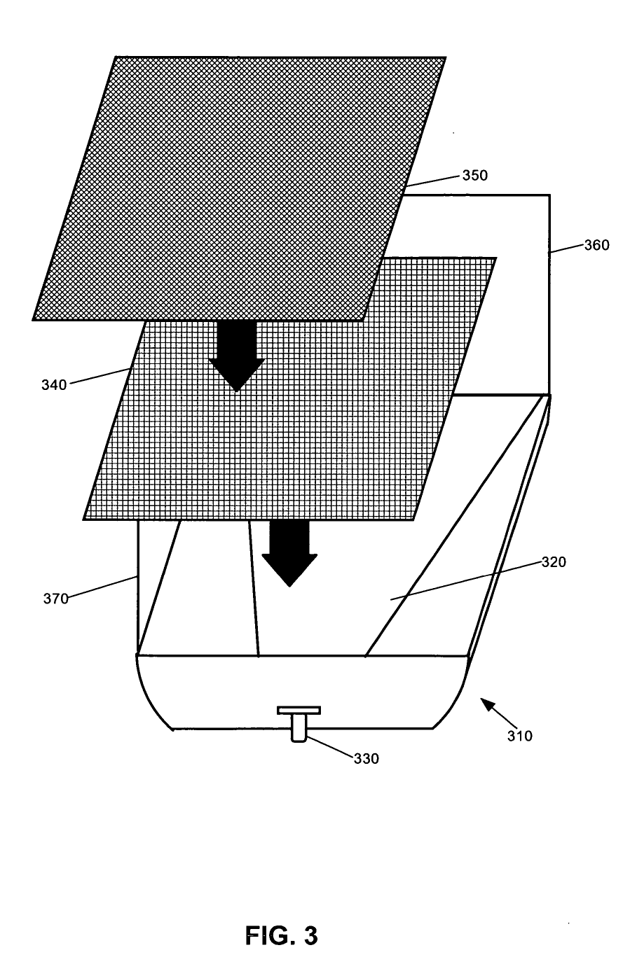

It will be recognized by the skilled artisan that the combination of the non-rigid permeable pad 230 and the rigid, mesh screen 220 can provide unique advantages in respect to cleaning and maintaining the portable pet waste station 200 of the present invention. In further illustration, FIG. 3 is a perspective view of the portable pet waste station of FIG. 2 configured with a non-rigid, washable pad and rigid, permeable mesh screen in accordance with the inventive arrangements. As shown in FIG. 3, the portable pet waste station 310 can include an upper urine collection chamber 320 having a sloping base so as to guide the flow of urine towards a hole (not shown) in communication with a lower urine reservoir chamber (not shown). The portable pet waste station 310 further can include convenience splash guards 360, 370. Finally, the portable pet waste station 310 can include a valve 330 through which urine can be disposed.

A rigid, mesh screen 340 can be lowered towards the top rim of the upper urine collection chamber 320 and can form the top surface of the upper urine collection chamber 320. Preferably, the rigid, mesh screen 340 can be formed from plastic or metal and can be configured to support the weight of a medium or large dog breed. A non-rigid, permeable pad 350 such as an artificial grass section, for example ASTROTURF, can be fit snuggly atop the mesh screen 340. Consequently, fecal matter can be collected with ease from the top of the non-rigid, permeable pad 350 while urine can pass through the non-rigid, permeable pad 350 and the rigid, mesh screen 340 into the upper urine collection chamber 320.

Most importantly, the non-rigid, permeable pad 350 can be removed from the mesh screen 340 and washed within a conventional washing machine, or disposed of without requiring the messy and uncomfortable task of hand-washing the permeable pad 350 as would be required in the case of a rigid, plastic or metal mesh. In this regard, the non-rigid nature of the permeable pad 350 provides significant advantages over the rigid mesh screens of the prior art as the non-rigid nature permits the insertion of the permeable pad 350 in a washing machine. The rigid mesh screen 340 also can be washed, albeit manually due to its rigid construction.

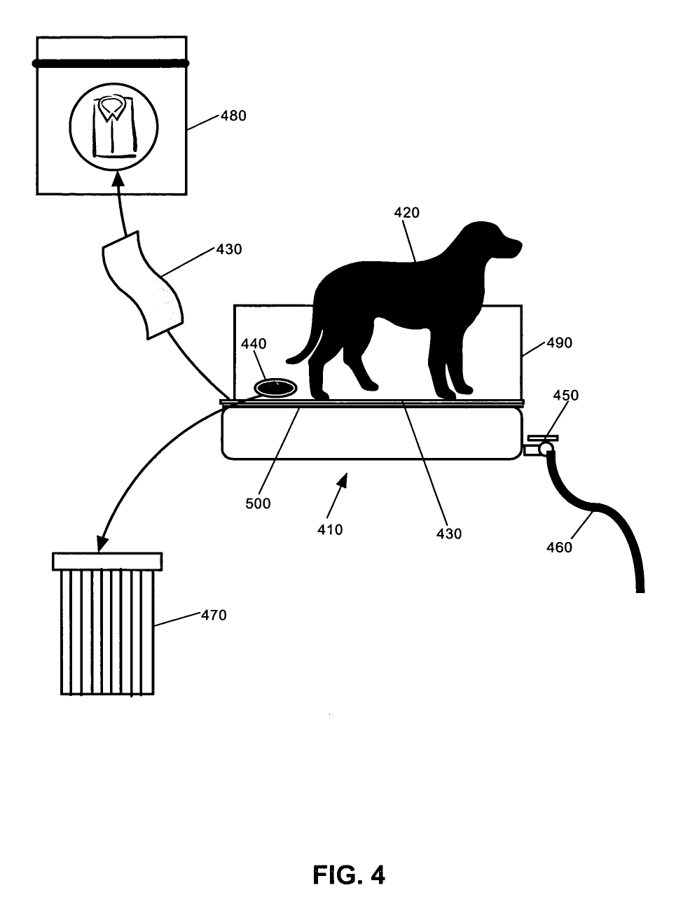

In further illustration of the advantageous use and maintenance of the portable pet station of FIGS. 2 and 3, FIG. 4 pictorially illustrates a system and method for collecting and disposing of pet waste. As shown in FIG. 4, a dog 420 can mount the portable pet waste station 410 to engage in an evacuation. The weight of the dog 420 can be supported by the combination of a rigid mesh screen 500 and a non-rigid, permeable pad 430. Fecal matter 440 can be collected at the surface of the non-rigid permeable pad 430 while the splash guard 490 can prevent unwanted splashing of urine outside of the portable pet waste station 410. Subsequently, the fecal matter 440 can be disposed of using a waste receptacle 470. Urine can flow through the non-rigid, permeable pad 430 into the portable pet waste station 410. The urine itself can be disposed of by actuating the valve 450 and guiding the urine through a hose 460 to a waste receiving site such as an outdoor lawn. Importantly, the non-rigid, permeable pad 430 can be removed and washed within a conventional washing machine 480 without requiring the manual cleaning associated with a rigid material such as a wire mesh.

The utility of the portable pet waste station of the present invention will be apparent to the skilled artisan. Given the size and construction of the portable pet waste station, the portable pet waste station can be packed for travel so that when a pet owner engages lodging in a hotel room or apartment unit, the pet waste station can be positioned on a balcony and the splash guards can be assembled for use. The disposal of any collected urine can be deferred until a convenient time without permitting the proliferation of urine odor. Alternatively, the attachment of a hose can guide urine away from the balcony onto a lawn or into a drain. Significantly, due to the non-rigid nature of the permeable pad, at any time the permeable pad can be removed and discarded or washed within a washing machine. By comparison, mere rigid mesh screens can be washed by hand only.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A portable pet waste station comprising:
a shell defining a urine collection chamber;
a rigid mesh screen disposed atop the urine collection chamber; and,
a non-rigid permeable pad disposed atop the rigid mesh shell, said non-rigid permeable pad being one of a washeable pad and a disposable pad.

2. The portable pet waste station of claim 1, further comprising a urine reservoir disposed below said urine collection chamber and communicatively coupled to said urine collection chamber with a hole.

3. The portable pet waste station of claim 2, wherein a bottom surface of said urine collection chamber is sloped towards said hole.

4. The portable pet waste station of claim 1, further comprising an actuatable valve affixed to said shell to permit draining of urine collected in the station to an exterior disposal location.

5. The portable pet waste station of claim 4, wherein said valve is configured for coupling to a hose.

6. The portable pet waste station of claim 1, wherein said rigid mesh shell is a plastic shell able to support the weight of a dog.

7. The portable pet waste station of claim 1, wherein said rigid mesh shell is a metal shell able to support the weight of a dog.

8. The portable pet waste station of claim 1, wherein said non-rigid permeable pad is an artificial grass section.

9. The portable pet waste station of claim 1, further comprising a first splash guard arranged perpendicularly to a horizontal plane defined by said non-rigid permeable pad.

10. The portable pet waste station of claim 9, further comprising a second splash guard arranged perpendicularly both to a horizontal plane defined by said non-rigid permeable pad, and a vertical plane defined by said first splash guard.

11. The portable pet waste station of claim 1, further comprising suction-cup feet affixed to said shell.

12. The portable pet waste station of claim 1, further comprising a cover configured to be secured to a top opening of said shell over said rigid mesh screen.
